(19) United States
(12) Patent Application Publication
(10) Pub. No.: US 2022/0363107 A1
(43) Pub. Date: Nov. 17, 2022

(54) AIR SANITATION SYSTEM FOR VEHICLES

(71) Applicants: Hyundai Motor Company, Seoul (KR); Kia Corporation, Seoul (KR)

(72) Inventor: Margaux Krause, Pinckney, MI (US)

(21) Appl. No.: 17/317,030

(22) Filed: May 11, 2021

(51) Int. Cl. B60H 1/24; B60H 3/06

(52) U.S. Cl. CPC B60H 1/243; B60H 3/06

(57) ABSTRACT

Methods and systems are described for air sanitation in vehicles. The system detects a change in a vehicle occupancy in a vehicle. The system then generates an air curtain zone in the vehicle based on the vehicle occupancy. The air curtain zone includes an air curtain to isolate air within the air curtain zone from a portion of the vehicle. The air curtain zone also includes a vent and an air filter to purify air in the air curtain zone.

### TECHNICAL FIELD

The present disclosure relates generally to air sanitation, and more particularly, to air sanitation for vehicles that decreases the amount of air shared among vehicle occupants.

### BACKGROUND

Generally, vehicles are capable of carrying multiple occupants. However, occupants may carry airborne illnesses that may pass to other occupants. Some occupants may be sensitive to bacteria or dust circulating in the air of the vehicle. Other occupants may be sensitive to odors or perfumes carried by occupants or animals. Accordingly, air sanitation within the vehicle may be required to keep the occupants healthy and comfortable.

Developed vehicles include air purifiers to clean circulating air inside the vehicle. However, contaminated air must circulate through the vehicle before sanitation occurs at the air purifier, potentially contaminating occupants inside the vehicle. More worrisome, the number of occupants may change during a single vehicle trip, potentially cross-contaminating future vehicle occupants with past vehicle occupants. Accordingly, there is a need for an improved air sanitation system within vehicles.

### SUMMARY

The present disclosure provides a sanitation system for vehicles that minimizes the amount of shared air among vehicle occupants. In one aspect, there is provided a system including at least one processor and at least one memory. The at least one memory may store instructions. When executed by the at least one data processor, the instructions may cause the at least one data processor to at least detect a change in a vehicle occupancy in a vehicle. The system then creates an air curtain zone in the vehicle based on the vehicle occupancy. The air curtain zone includes an air curtain to isolate air within the air curtain zone from a portion of the vehicle. The air curtain zone also includes a vent and an air filter to purify air in the air curtain zone.

In some variations, one or more of the features disclosed herein including the following features may optionally be included in any feasible combination. In some variations, the air curtain is positioned between a set of seats in the vehicle and the air curtain is a laminar air curtain blowing air in a downward direction and suctioning air at a base of the air curtain. The air curtain zone includes an additional air curtain, the additional air curtain being positioned between a different set of seats in the vehicle. In some variations, the air filter is located at the vent correlating to the air curtain zone and wherein the air filter removes microbes and de-ionizes air in the air curtain zone. In some variations, the vent is configured to direct air at a vehicle seat in a vortex formation.

Additionally, creating the air curtain zone includes activating the air curtain to isolate the air curtain zone from a different air curtain zone and sanitizing air in the air curtain zone by removing contaminated air through the vent and purifying contaminated air at the air filter corresponding to the air curtain zone. In some variations, air in the air curtain zone is sanitized before an occupant enters the vehicle. In some variations, the creating the air curtain zone includes disabling the air curtain to integrate the air curtain zone into a different air curtain zone and sanitizing air in the air curtain zone by removing contaminated air through the vent and purifying contaminated air at the air filter corresponding to the air curtain zone. In some variations, air in the air curtain zone is sanitized before integrating air in the air curtain zone into the different air curtain zone

Further, the air curtain zone further includes an air capture vent and a channel to intake air from the air curtain zone to recirculate air within the air curtain zone, the air capture vent and the channel configured to maintain air in the air curtain zone isolated from air in the portion of the vehicle. In some variations, the change in the vehicle occupancy is determined by at least one of a door sensor, a pressure sensor, a camera, a new ride notification, a navigation route ending, and a door unlocking. In some variations, the vehicle occupancy is determined by at least one of a pressure sensor in a vehicle seat, a door sensor, a camera, or a ride notification.

Implementations of the current subject matter may include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer-implemented methods consistent with one or more implementations of the current subject matter can be implemented by one or more data processors residing in a single computing system or multiple computing systems.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 depicts an example of a vehicle with multiple air curtain zones in which each air curtain zone includes an air curtain and a personal air vortex;

FIG. 2A depicts an example of a vehicle with two occupants with two air curtain zones;

FIG. 2B depicts another example of a vehicle with three occupants with three air curtain zones;

FIG. 3A depicts an example of a change in air curtain zones as the vehicle adds an occupant;

FIG. 3B depicts an example of a change in air curtain zones as the vehicle loses an occupant;

FIG. 4 depicts an example of a change in occupants in the vehicle while the number of air curtain zones remains the same;

FIG. 5A depicts an example of an air vent directing air in a vortex formation from the ceiling of the car to the floor of the car;

FIG. 5B depicts an example of an air vent directing air in a vortex formation from the floor of the car to the ceiling of the car;

FIG. 6 depicts an example of a diagram of an air curtain zone map with corresponding blowers and air capture vents;

FIG. 7 depicts an example of a vehicle in which an occupant has inserted a limb through one of the air curtain zones;

FIG. 8 depicts an example of a vehicle in which an air curtain zone is defective;

FIG. 9A depicts an example of a table illustrating a state of operation for climate control components of the vehicle depending on the number of occupants and context;

FIG. 9B depicts another example of a table illustrating a state of operation for climate control components of the vehicle depending on the number of occupants and context; and

FIG. 10 depicts a block diagram illustrating a computing system consistent with implementations of the current subject matter.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). The vehicle may be operated by a vehicle occupant or may be autonomously operated. As referred to herein, a hybrid vehicle is a vehicle that has two or more sources of power, for example both gasoline-powered and electric-powered vehicles.

Although exemplary embodiments are described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present embodiments may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Air curtain zones may be generated based on vehicle occupancy. A change in vehicle occupancy may trigger the generation or removal of an air curtain zone. The air curtain zone may include an air curtain that isolates air within the air curtain zone from other portions of the vehicle. That is, no air outside the air curtain zone may enter. The air curtain zone may also include a vent and an air filter to purify air in the air curtain zone. The air curtain may be a laminar air curtain blowing air in a downward direction. At the bottom end of the air curtain, air may be suctioned to maintain air isolation within the air curtain zone. The bottom end of the air curtain may be located at the seat of the vehicle, the floor of the vehicle, or another location of the vehicle.

Air curtains may divide the seats of the vehicle into air curtain zones. For example, an air curtain between two rear passenger seats may divide the vehicle into two air curtain zones. In another example, an air curtain between the driver seat and the rear passenger seat may divide the vehicle into two air curtain zones. In another example, an air curtain behind the driver seat and an air curtain to the right of the driver seat may divide the vehicle into two air curtain zones.

An air filter in a vent may treat air within the air curtain zone. The air filter may remove microbes, dust particles, and de-ionize the air in the air curtain zone. The vent may direct air at a vehicle seat in a vortex formation. An air curtain zone may include an air capture vent and a channel to intake air from the air curtain zone to recirculate the air in the air curtain zone. The air capture vent and the channel may be isolated from other air capture vents and channels to maintain air in the air curtain zone separate from air from the rest of the vehicle.

To generate an air curtain zone, an air curtain may be activated. Activating an air curtain may isolate air in the air curtain zone from air in a different air curtain zone. Upon activating the air curtain, the air may be sanitized in the air curtain zone by removing contaminated air through the vent and purifying contaminated air. The generation of an air curtain zone may be triggered by an occupant entering the vehicle. Alternatively, and/or additionally, an air curtain zone may be generated by disabling an air curtain. The air curtain zone may be integrated with another air curtain zone. Before integrating the two air curtain zones, the air may be sanitized by removing the contaminated air through the vent and purifying that contaminated air at the air filter.

The methods, systems, apparatuses, and non-transitory storage mediums described herein generate an air curtain zone in a vehicle in response to determining a change in a vehicle occupancy. The various embodiments also sanitize air curtain zones when occupants cross air curtain zones or instruct occupants to move to another air curtain zone if the air curtain zone is dysfunctional.

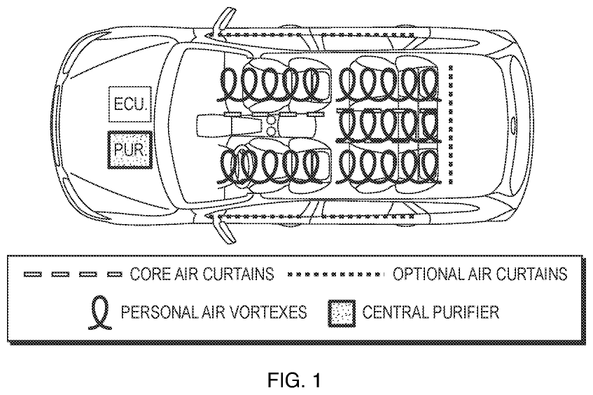

FIG. 1 depicts an example of a vehicle with multiple air curtain zones in which each air curtain zone includes an air curtain and a personal air vortex. The vehicle may include a processer, a memory, a climate conditioning system, a central air purifier, air curtains, air blowers, air vents, and air capture vents. The processor may be communicatively coupled to the climate conditioning system, the central air purifier, the air curtains, the air blowers, the air vents, and the air capture vents. The processor may be communicatively coupled to a door sensor, a pressure sensor, a camera, or a vehicle seat. The processor may be communicatively coupled to a device configured to send a data reading indicating a new ride request, a new occupant pickup, or a navigation route ending. The processor may be communicatively coupled to a memory including data indicating a new ride request, a new occupant pickup, or a navigation route ending. The processor may be communicatively coupled to rideshare apps.

The processor may detect a change in a vehicle occupancy. The processor may detect a change in vehicle occupancy by a data reading from a door sensor, a vehicle seat, a pressure sensor, a camera, a new ride notification, a navigation route ending, or a door unlocking. For example, the processor may detect a change in vehicle occupancy based on pressure sensors in the vehicle seats. Additionally, the processor may track the number of occupants and their locations in the vehicle based on a vehicle seat, a door sensor, a camera, or a ride notification. For example, the processor may track the number of occupants in the vehicle based on a rideshare app indicating that two occupants are to be dropped off at the next stop.

The controller may be configured to generate an air curtain zone in the vehicle based on the vehicle occupancy. The number of air curtain zones may correspond to the number of vehicle occupants. The controller may be configured to generate or disable an air curtain zone as the number of vehicle occupants change. Additionally, the controller may be configured to generate an air curtain zone by activating an air curtain. Each air curtain zone may include an air curtain that isolates air within the air curtain zone from other portions of the vehicle. The air curtain may be a laminar air curtain blowing air in a downward direction. The controller may be configured to activate a top portion and a bottom portion of the air curtain to maintain air isolation within the air curtain zone. The bottom portion of the air curtain may be located directly below the upper portion of the air curtain. For example, the top portion of the air curtain may be at the vehicle ceiling and the bottom portion of the vehicle at the seat of the vehicle, the floor of the vehicle, or another location of the vehicle. The controller may also be configured to activate a blower and an air capture corresponding to the air curtain zone.

The controller may be configured to operate various components of the climate conditioning system. For example, the controller may be configured to activate a blower. The blower may blow air through an air vent corresponding to the air curtain zone. The air vent may direct air at a vehicle seat in a vortex formation. The number of blowers and air vents in the vehicle may correspond to the number of potential air curtain zones in the vehicle. In another example, the processor may activate an air capture vent. The air capture vent may intake air through the air capture vent corresponding to the air curtain zone. The number of air capture vents in the vehicle may correspond to the number of air curtain zones in the vehicle.

The vehicle may include a central air purifier and modular air purifiers corresponding to air curtain zones. The modular air purifiers may be located at the air vents corresponding to the various air curtain zones. The air filters may remove microbes, dust particles, and de-ionize the air in the air curtain zone. The vehicle may also include air capture vents to suction in air from the air curtain zone to recirculate the air in the air curtain zone through individualized channels. The air capture vents and the channels may be isolated to maintain air in the air curtain zone separate from air from the rest of the vehicle.

To generate an air curtain zone, the controller may be configured to activate an air curtain to isolate the air curtain zone from a different air curtain zone. Upon activating the air curtain, the controller may be configured to activate a vent for sanitizing the air in the air curtain zone. Additionally, and/or alternatively, the controller may be configured to disable an air curtain to integrate the air curtain zone with another air curtain zone. Before integrating the two air curtain zones, the controller may be configured to activate a vent for sanitizing the air in the air curtain zone.

As depicted in FIG. 1, air curtains may divide the driver seat from the front passenger seat, the driver seat from the back left passenger seat, the front passenger seat from the back right passenger seat, and the back left passenger seat from the back right passenger seat. Air curtains may also be positioned at each door opening of the vehicle. In 5-door vehicles, an air curtain may be positioned behind the back left passenger seat and the back right passenger seat. Each seat in the vehicle may include a vent configured to direct air at the vehicle seat in a vortex formation. The vortex airflow concentrates the local air on a specific passenger and reduces mixing of air across zones.

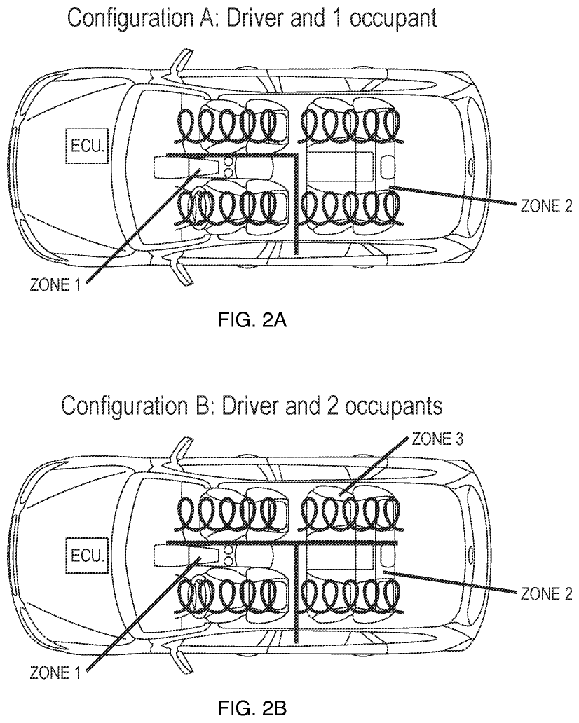

FIG. 2A depicts an example of a vehicle with two occupants with two air curtain zones. The number of air curtain zones may match the number of vehicle occupants. In the depicted example, one air curtain zone may be air space corresponding to the driver seat and the other air curtain zone may be the remaining portion of the vehicle. The air curtain zone corresponding to the airspace of the driver seat may be generated by activating an air curtain behind the driver seat and an air curtain to a side of the driver seat. In another example, the air curtain zone corresponding to the airspace of the driver seat may be generated by activating an air curtain behind the driver seat and an air curtain behind the front passenger seat. The air from the two air curtain zones remains isolated from each other.

FIG. 2B depicts another example of a vehicle with three occupants with three air curtain zones. The number of air curtain zones may match the number of vehicle occupants. In the depicted example, one air curtain zone may correspond to airspace around the driver seat, one air curtain zone may correspond to airspace around the rear left seat, and the other air curtain zone may be the remaining portion of the vehicle. The air curtain zone corresponding to the airspace of the driver seat may be generated by activating an air curtain behind the driver seat and an air curtain to a side of the driver seat. The air curtain zone corresponding to the airspace of the rear left seat may be generated by further activating an air curtain to the side of the rear left seat. The other air curtain zone may be the remaining portion of the vehicle.

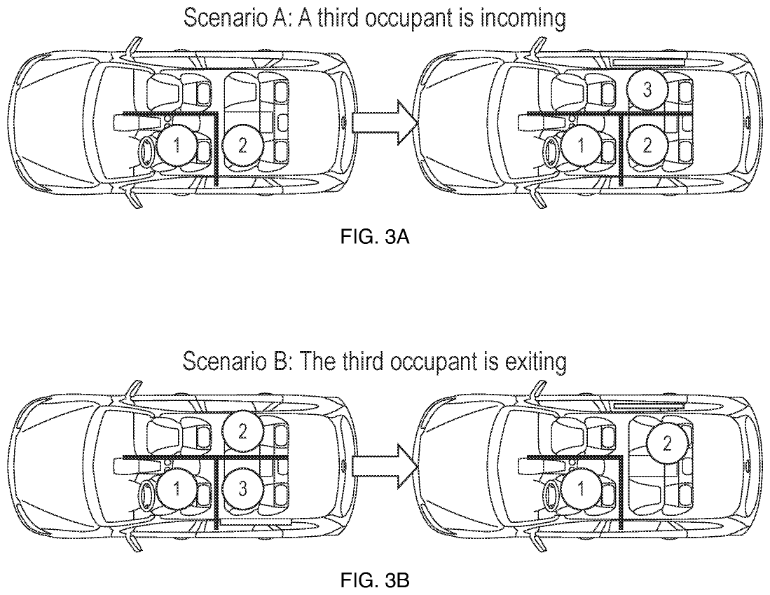

FIG. 3A depicts an example of a change in air curtain zones as the vehicle adds an occupant. As depicted, two occupants may be present in the vehicle: one in the driver seat and one in the rear left seat. A third occupant may enter the vehicle through a rear right door.

In the situation of an incoming occupant, the controller may be configured to generate an air curtain zone to accommodate the third occupant. The controller may be configured to activate an air curtain dividing the back rear seats to isolate the air between the other air curtain zones. After activating the air curtain but prior to the third occupant arriving, the air in the newly generated air curtain zone may be sanitized by using a high-speed air vortex to push out contaminated air to the air purifier. As the incoming third occupant enters following sanitation, an air curtain at the door through which the occupant enters may be activated while the door is open.

FIG. 3B depicts an example of a change in air curtain zones as the vehicle loses an occupant. As depicted, three occupants may be present in the vehicle: one in the driver seat, one in the rear right seat, and one in the rear left seat. An occupant may exit the vehicle through a rear left door.

In the situation of an occupant exiting the vehicle, the controller may be configured to integrate an air curtain zone into another air curtain zone to minimize the number of air curtain zones to save energy. The controller may be configured to activate a high-speed vortex to sanitize the air in the air curtain zone by pushing air out to the air purifier once the occupant has left the vehicle. After sanitizing the air, the controller may be configured to disable an air curtain dividing the back rear seats to integrate the two air curtain zones together. Vortex airflow may be at a normal rate following the completion of sanitizing the vehicle. The controller may also be configured to activate an air curtain at the door through which the occupant exits as the occupant exits.

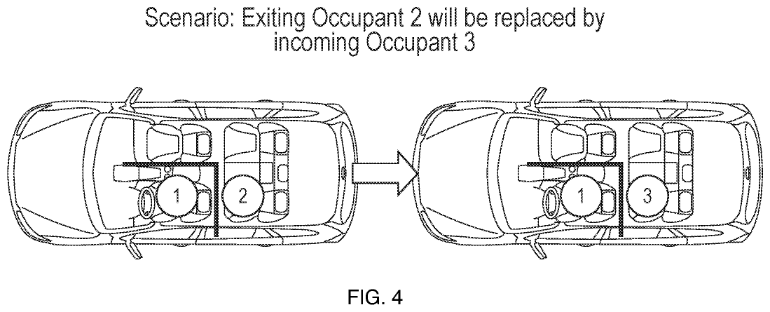

FIG. 4 depicts an example of a change in occupants in the vehicle while the number of air curtain zones remains the same. As depicted, two occupants may be present in the vehicle: one in the driver seat and one in the rear left seat. The second occupant may leave the vehicle through the rear left door and a third occupant may enter the vehicle through the rear left door.

In the situation of a change in occupants but the total occupancy remaining the same, the processor may activate a high-speed vortex to sanitize the air in the air curtain zone by pushing air out to the air purifier once the second occupant has left the vehicle. The controller may be configured to operate the vehicle door to lock during the sanitation process to avoid exposing the third incoming occupant to contaminated air. After sanitizing the air, the controller may be configured to output a light, an audible sound, a text message, or other notification to indicate the vehicle is clean to the incoming third occupant. The controller may be configured to activate an air curtain at the door through which the third occupant enters while the door is open.

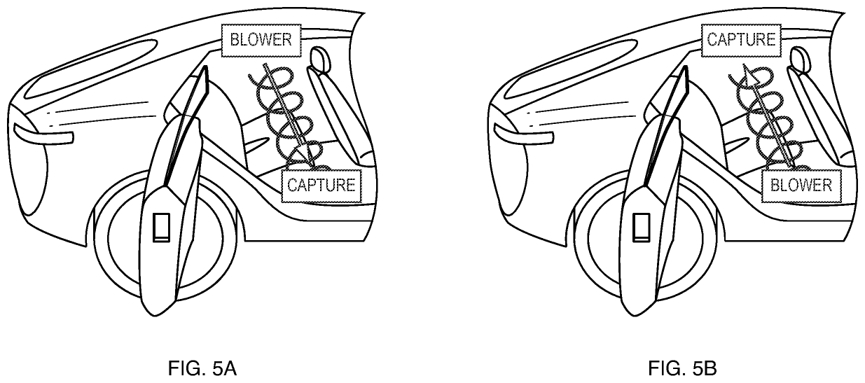

FIG. 5A depicts an example of an air vent directing air in a vortex formation from the ceiling of the car to the floor of the vehicle. The climate control system may be configured to generate warm air or cold air relative to the internal temperature of the vehicle. The direction of the airflow may change based on the temperature of the air. For example, the climate control system may be configured to direct warm air to blow from the floor of the vehicle to the ceiling of the vehicle. The climate control system may be configured to blow warm air upwards as warm air tends to rise. Blowing air in the direction that the air naturally circulates may enhance capturing the [1] contaminated air into the air capture vent.

FIG. 5B depicts an example of an air vent directing air in a vortex formation from the floor of the vehicle to the ceiling of the vehicle. The climate control system may be configured to generate warm air or cold air relative to the internal temperature of the vehicle. The direction of the airflow may change based on the temperature of the air. For example, the vortex airflow may blow cold air from the ceiling of the vehicle to the floor of the vehicle. The climate control system may be configured to blow cold air downwards as cold air tends to fall. Blowing air in the direction that the air naturally circulates may enhance contaminated air into the air capture vent.

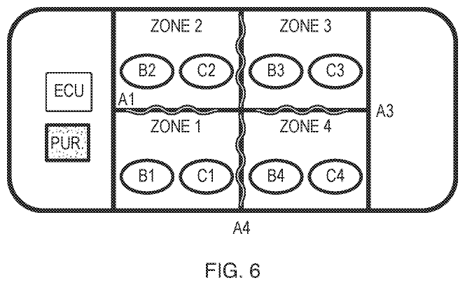

FIG. 6 depicts an example of a diagram of an air curtain zone map with corresponding blowers and air capture vents. The controller having a processor and a memory may be configured to map different air curtain zones. The mapping of different air curtain zones may be represented on an air curtain zone map. The air curtain zone map may correspond to the seating in a vehicle. For example, a four-seat vehicle would have four air curtain zones in its air curtain zone map. In another example, a five-seat vehicle would have five air curtain zones in its air curtain zone map. Each of the air curtain zones may correspond to a blower and an air capture vent. Each blower and air capture vent is communicatively coupled to the processor.

The controller may be configured to activate an air curtain zone on the map based on an incoming occupant. As the occupant enters, the controller may be configured to activate the blower and the air capture vent corresponding to the air curtain zone where the incoming occupant sits. Similarly, the controller may be configured to integrate an air curtain zone on the map based on an exiting occupant. As the occupant exits the vehicle, the controller may be configured to disable the blower and the air capture vent corresponding to the air curtain zone where the exiting occupant left. The memory may be configured to store a record of the number of occupants inside of the vehicle and which air curtain zones are available for occupancy. The controller may be configured to determine which air curtain zone to activate as an occupant arrives. The controller may be configured to determine to integrate an empty curtain zone into another air curtain zone as an occupant leaves.

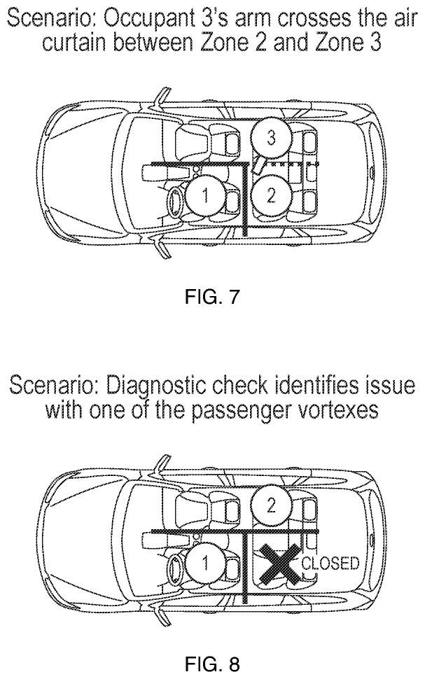

FIG. 7 depicts an example of a vehicle in which an occupant has inserted a limb through one of the air curtain zones. Air contamination may occur when an occupant inserts a limb into another air curtain zone. The air contamination may be remedied by detecting the limb, notifying the occupants, and sanitizing the air.

A sensor may be configured to detect if an occupant has crossed an air curtain zone. The sensor may be a camera, an infrared light, an air curtain flow sensor, or a motion sensor. The sensor may be communicatively coupled to the controller. The controller may be configured to analyze the data readings from the sensor to determine the length and severity of the air curtain zone crossing. For example, a motion sensor may be configured to detect that an elbow temporarily crossed the air curtain zone for less than two seconds. Based on these data readings, the controller may be configured to determine that the intensity of the contamination is low. In another example, a camera may be configured to detect that the occupant's head crossed the air curtain zone for greater than 10 seconds. Based on these data readings, the controller may be configured to determine that the intensity of the contamination is high.

The controller may be configured to adjust the climate system settings based on the intensity of the contamination. The controller may be configured to set the climate system setting to an increased intensity of the air capture suction system in the contaminated air curtain zone. The controller may be configured to set the climate system setting to an increased air purification system to quickly scrub the contaminated air. The controller may be configured to check air quality to determine whether the quality satisfies a predetermined air quality threshold before restoring the climate system setting to normal.

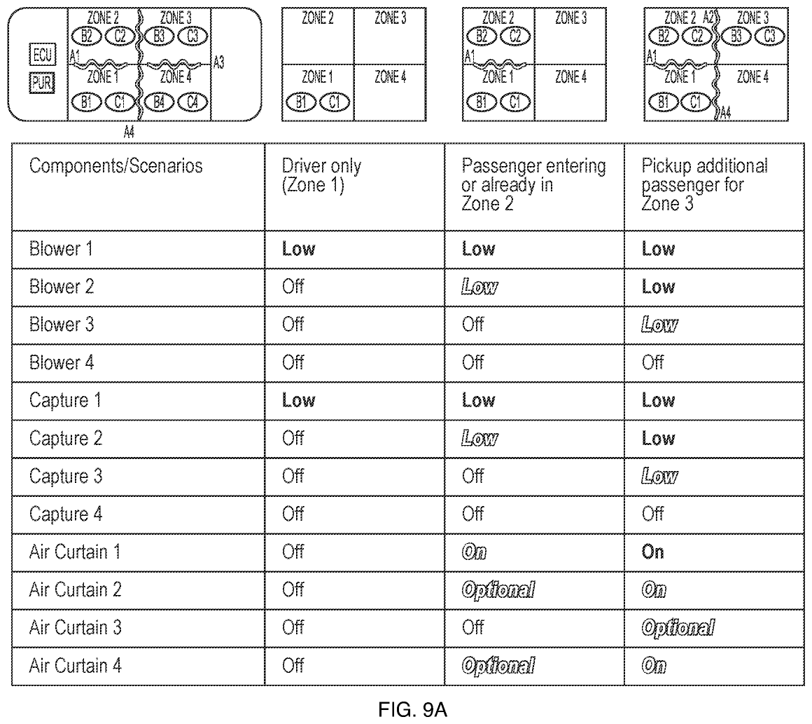

FIG. 8 depicts an example of a vehicle in which an air curtain zone is defective. The controller may be configured to monitor the air quality in each of the air curtain zones. When the air quality in any of the air curtain zones is less than the threshold, the controller may be configured to adjust the climate system settings to reduce the contamination in the malfunctioning air curtain zone. If adjusting the climate system settings does not satisfy the threshold, the controller may be configured to determine that the air curtain zone is malfunctioning.

In response to detecting a malfunctioning air curtain zone, the controller may be configured to transmit a message that all occupants should move out of the air curtain zone. The message may be a light, a text message, an audible voice, or an icon on the dashboard. The controller may be configured to activate a functional air curtain zone to which an occupant may relocate. The controller may be configured to notify the occupant or the driver of a seat corresponding to a functional air curtain zone. Additionally, the controller may be configured to lock the door adjacent to the seat that corresponds to the malfunctioning air curtain zone.

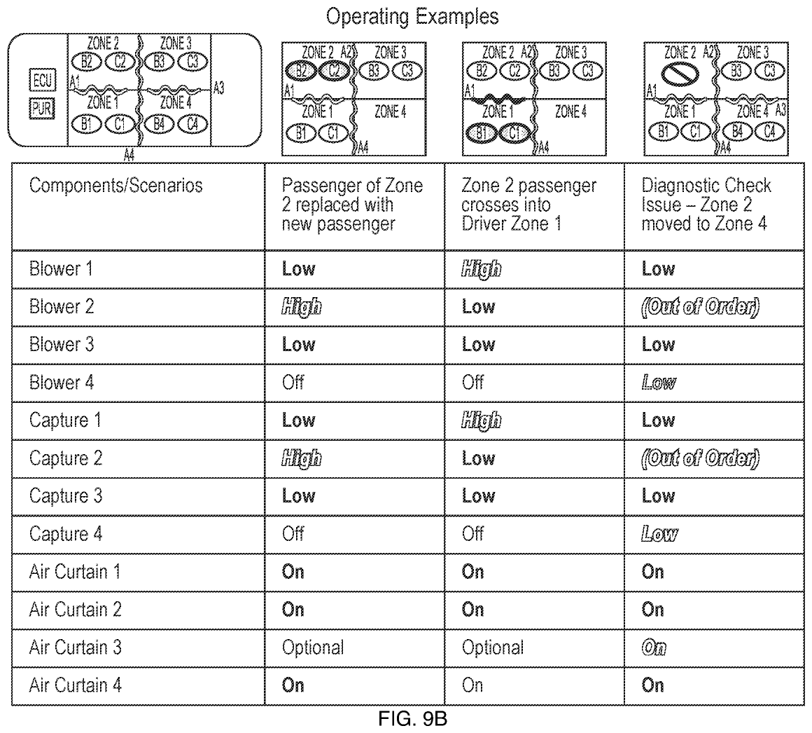

FIG. 9A depicts an example of a table illustrating a state of operation for climate control components of the vehicle based on the number of occupants and context. The controller may be communicatively coupled to blowers, air capture vents, and air curtains corresponding to the air curtain zones. The controller may be configured to activate the blowers, air capture vents, and air curtains corresponding to the air curtain zones based on the number of occupants, where the occupants are seated, and whether occupants are entering or leaving the vehicle.

For example, the controller may be configured to activate the first blower and the first air capture vent when the driver is the only occupant in the vehicle. In another example, the processor may activate the two blowers, two air capture vents, and at least one air curtain when the driver and another occupant are in the vehicle. In another example in which an occupant is entering the vehicle, the controller may be configured to activate three blowers corresponding to where the occupants are seated, the controller may be configured to activate three air capture vents corresponding to where the occupants are seated, and the controller may be configured to activate at least three air curtains corresponding to where the occupants are seated.

FIG. 9B depicts another example of a table illustrating a state of operation for climate control components of the vehicle depending on the number of occupants and context. The controller may be communicatively coupled to blowers, air capture vents, and air curtains corresponding to the air curtain zones. The controller may be configured to activate the blowers, air capture vents, and air curtains corresponding to the air curtain zones based on the number of occupants, where the occupants are seated, and whether occupants are entering or leaving the vehicle.

For example, a vehicle may contain three occupants in which one occupant is about to be replaced by another occupant. The controller may be configured to activate three blowers corresponding to where the occupants are seated, the controller may be configured to activate three air capture vents corresponding to where the occupants are seated, and the controller may be configured to activate at least three air curtains corresponding to where the occupants are seated. The controller may be configured to activate the blower and the air capture vent of the air curtain zone corresponding to the incoming occupant to a high setting.

In another example, a vehicle may contain three occupants in which one occupant crosses over into another air curtain zone. The controller may be configured to activate three blowers corresponding to where the occupants are seated, [2]three air capture vents corresponding to where the occupants are seated, and at least three air curtains corresponding to where the occupants are seated. The controller may further be configured to activate the blower and the air capture vent of the air curtain zone corresponding to the contaminated air curtain zone to a high setting.

In another example, a vehicle with one malfunctioning air curtain zone may contain three occupants. The controller may be configured to activate three blowers corresponding to where the occupants are seating, three air capture vents corresponding to where the occupants are seated, and at least three air curtains corresponding to where the occupants are seated. The controller may further be configured to disable the blower and the air capture vent of the air curtain zone corresponding to the malfunctioning air curtain zone.

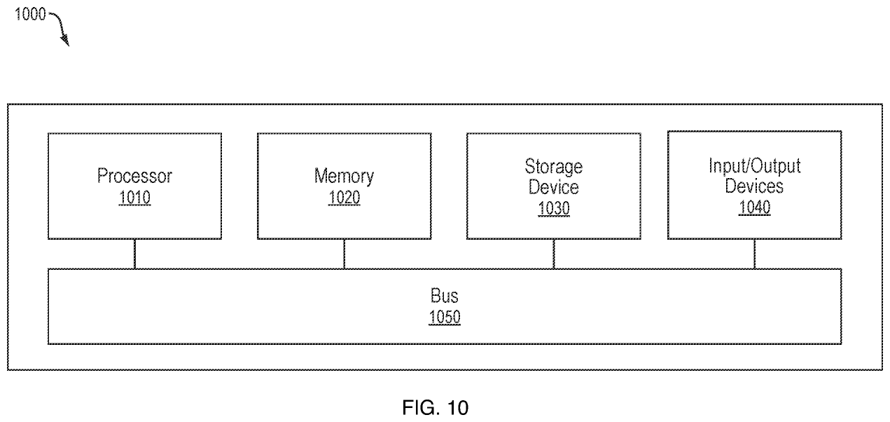

FIG. 10 depicts a block diagram illustrating a computing system 1000 consistent with implementations of the current subject matter. Referring to FIGS. 1-10, the computing system 1000 may be used to generate an air curtain zone based on a change in vehicle occupancy. For example, the computing system 1000 may implement a user equipment, a personal computer, or a mobile device.

As shown in FIG. 10, the computing system 1000 may include a processor 1010 (of the controller), a memory 1020, a storage device 1030, and an input/output device 1040. The processor 1010, the memory 1020, the storage device 1030, and the input/output device 1040 may be interconnected via a system bus 1050. The processor 1010 may be configured to process instructions for execution within the computing system 1000. The executed instructions may implement one or more components of, for example, cross-cloud code detection. In some example embodiments, the processor 1010 may be a single-threaded processor. Alternately, the processor 1010 may be a multi-threaded processor. The processor 1010 may be configured to process instructions stored in the memory 1020 and/or on the storage device 1030 to display graphical information for a user interface provided via the input/output device 1040.

The memory 1020 is a computer-readable medium such as volatile or non-volatile that stores information within the computing system 1000. The memory 1020 may be configured to store data structures representing configuration object databases, for example. The storage device 1030 may be configured to provide persistent storage for the computing system 1000. The storage device 1030 may be a floppy disk device, a hard disk device, an optical disk device, or a tape device, or other suitable persistent storage means. The input/output device 1040 provides input/output operations for the computing system 1000. In some example embodiments, the input/output device 1040 may include a keyboard and/or pointing device. In various implementations, the input/output device 1040 may include a display unit configured to display graphical user interfaces.

According to some exemplary embodiments, the input/output device 1040 may be configured to provide input/output operations for a network device. For example, the input/output device 1040 may include Ethernet ports or other networking ports to communicate with one or more wired and/or wireless networks (e.g., a local area network (LAN), a wide area network (WAN), the Internet, a public land mobile network (PLMN), and/or the like).

In some exemplary embodiments, the computing system 1000 may be used to execute various interactive computer software applications that may be used for organization, analysis and/or storage of data in various formats. Alternatively, the computing system 1000 may be used to execute any type of software applications. These applications may be used to perform various functionalities, e.g., planning functionalities (e.g., generating, managing, editing of spreadsheet documents, word processing documents, and/or any other objects, etc.), computing functionalities, communications functionalities, etc. The applications may include various add-in functionalities or may be standalone computing items and/or functionalities. Upon activation within the applications, the functionalities may be used to generate the user interface provided via the input/output device 1040. The user interface may be generated and presented to a user by the computing system 1000 (e.g., on a computer screen monitor, etc.).

The technical advantages presented herein may result in an efficient way to sanitize air in a vehicle that prevents cross-contamination while minimizing energy consumption. Sanitizing air in a vehicle consumes significant energy due to engaging various climate control settings. This energy cost may significantly increase as the vehicle occupants and the occupancy change over time. For example, vehicle occupancy and occupants may frequently change in a vehicle participating in a rideshare business. Properly generating air curtain zones protects the health of all occupants while balancing the energy demand on the vehicle.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A system comprising:
a processor;
a non-transitory computer-readable storage medium storing instructions that, when executed by the processor, cause the processor to perform operations comprising:
detecting a change in a vehicle occupancy in a vehicle; and
generating an air curtain zone in the vehicle based on the vehicle occupancy, the air curtain zone including an air curtain to isolate air within the air curtain zone from a portion of the vehicle, the air curtain zone including a vent and an air filter to purify air in the air curtain zone.

2. The system of claim 1, wherein the air curtain is positioned between a set of seats in the vehicle and the air curtain is a laminar air curtain blowing air in a downward direction and suctioning air at a base of the air curtain.

3. The system of claim 1, wherein the air curtain zone includes an additional air curtain, the additional air curtain being positioned between a different set of seats in the vehicle.

4. The system of claim 1, wherein the air filter is located at the vent correlating to the air curtain zone and wherein the air filter removes microbes and de-ionizes air in the air curtain zone.

5. The system of claim 1, wherein the vent is configured to direct air at a vehicle seat in a vortex formation.

6. The system of claim 1, wherein creating the air curtain zone includes activating the air curtain to isolate the air curtain zone from a different air curtain zone and sanitizing air in the air curtain zone by removing contaminated air through the vent and purifying contaminated air at the air filter corresponding to the air curtain zone.

7. The system of claim 6, wherein air in the air curtain zone is sanitized before an occupant enters the vehicle.

8. The system of claim 1, wherein creating the air curtain zone includes disabling a previously active air curtain to integrate the preexisting air curtain zone into a different air curtain zone and sanitizing air in this new air curtain zone by removing contaminated air through the vent and purifying contaminated air at the air filter corresponding to the air curtain zone.

9. The system of claim 8, wherein air in the preexisting air curtain zone is sanitized before integrating air in the preexisting air curtain zone into the different air curtain zone.

10. The system of claim 1, wherein the air curtain zone further includes an air capture vent and a channel to intake air from the air curtain zone to recirculate air within the air curtain zone, the air capture vent and the channel configured to maintain air in the air curtain zone isolated from air in the remaining portion of the vehicle.

11. The system of claim 1, wherein the change in the vehicle occupancy is determined by at least one of a door sensor, a pressure sensor, a camera, a new ride notification, a navigation route ending, and a door unlocking.

12. The system of claim 1, wherein the vehicle occupancy is determined by at least one of a pressure sensor in a vehicle seat, a door sensor, a camera, or a ride notification.

13. An air sanitation system for vehicles, comprising:
a vent disposed within the vehicle;
a plurality of air filters configured to purify air within the vehicle;
a plurality of air curtains forming air curtain zones within an interior of the vehicle, wherein the air curtains isolate air within each air curtain zone; and
a controller configured to:
detect a change in a vehicle occupancy in the vehicle; and
generate the air curtain zone in the vehicle based on the vehicle occupancy.

14. The system of claim 13, wherein each air curtain is positioned between a set of seats in the vehicle and each air curtain is a laminar air curtain blowing air in a downward direction and suctioning air at a base of the air curtain.

15. The system of claim 13, wherein the air curtain zone includes an additional air curtain, the additional air curtain being positioned between a different set of seats in the vehicle.

16. The system of claim 13, wherein the air filter is located at the vent correlating to the air curtain zone and wherein the air filter removes microbes and de-ionizes air in the air curtain zone.

17. The system of claim 13, wherein the vent houses a vortex fan and is configured to direct air at a vehicle seat in a vortex formation.

18. The system of claim 13, wherein generating the air curtain zone includes activating an air curtain to isolate the air curtain zone from a different air curtain zone and sanitizing air in the air curtain zone by removing contaminated air through the vent and purifying contaminated air at the air filter corresponding to the air curtain zone.

19. The system of claim 18, wherein air in each air curtain zone is sanitized before an occupant enters the vehicle.

20. A non-transitory computer-readable storage medium storing instructions that, when executed by a processor, cause the processor to perform operations comprising:
detecting a change in a vehicle occupancy in a vehicle; and
generating an air curtain zone in the vehicle based on the vehicle occupancy, the air curtain zone including an air curtain to isolate air within the air curtain zone from a portion of the vehicle, the air curtain zone including a vent and an air filter to purify air in the air curtain zone.
